(19) United States
(12) Patent Application Publication
(10) Pub. No.: US 2009/0259966 A1
(43) Pub. Date: Oct. 15, 2009

(54) INFORMATION PROCESSING APPARATUS, WINDOW DISPLAY METHOD, AND COMPUTER READABLE MEDIUM TO STORE DISPLAY CONTROL PROGRAM

(76) Inventor: KENTARO HARA, Tokyo (JP)

Correspondence Address: NEC CORPORATION OF AMERICA, 6535 N. STATE HWY 161, IRVING, TX, 75039, US

(21) Appl. No.: 12/406,547

(22) Filed: Mar. 18, 2009

(30) Foreign Application Priority Data
Apr. 9, 2008 (JP) 2008-101403

(51) Int. Cl. G06F 3/048

(52) U.S. Cl. 715/796

(57) ABSTRACT

The information processing apparatus which performs multi-window display control includes a window change unit 102 to search among windows displayed on the screen for a window which at least partially overlaps an area identified based on a designated position and to change the display of the found window so that the found window will be sequentially displayed in the foreground on the screen.

### INCORPORATION BY REFERENCE

This application is based upon and claims the benefit of priority from Japanese patent application No. 2008-101403, filed on Apr. 9, 2008, the disclosure of which is incorporated herein in its entirety by reference.

### TECHNICAL FIELD

The present information relates to an information processing apparatus, and more specifically, to an information processing apparatus, a window display method, and a computer readable medium to store a display control program which performs multi-window display control.

### BACKGROUND ART

Multi-window display schemes to display multiple windows simultaneously are widely used for the operation screens of personal computers and various other kinds of information equipment. A typical multi-window display scheme allows users to, for example, quickly change between currently running multiple application software and move user data between multiple application software.

Many of the multi-window systems used today adopt overlap display mode, wherein windows can be displayed in an overlapping form. Since windows are displayed overlapping each other in overlap display mode, it is desirable that a user can easily change between windows to display his/her desired window in the foreground.

An example of this kind of prior art is the one disclosed in Japanese Patent Laying-Open No. 04-215122 (Patent Literature 1). In this art, the window over which the pointer of a pointing device, such as a mouse, is located for a predetermined length of time is displayed in the foreground. Therefore, a user can easily specify a change-to window.

The prior art disclosed in Japanese Patent Laying-Open No. 07-261733 (Patent Literature 2), on the other hand, changes the order of overlapping windows when a specific operation (action) is performed by the pointing device, regardless of the location of the pointer on the screen. By this, a user can change between windows simply by performing the specific operation, without having to move the pointer onto the desired window.

Patent Literature 1: Japanese Patent Laying-Open No. 04-215122

Patent Literature 2: Japanese Patent Laying-Open No. 07-261733

However, with the multi-window display schemes of these prior arts, users may not be able to display their desired window in the foreground quickly, especially when many windows are overlapping each other. For example, in order to select a window using a pointing device, which is the most commonly performed operation to display the desired window in the foreground, the window to be displayed in the foreground must be visible to the user. In other words, if the desired window is entirely hidden behind the other windows so that the pointer cannot be placed over that window, it is impossible to display the desired window in the foreground. This is also true with the prior art of Patent Literature 1.

Furthermore, in the art of Patent Literature 2, since the relative positions of overlapping windows are changed in a specific order, it may take some time before the desired window is displayed in the foreground. Thus, users may not be able to use the windows in an intuitive manner, in particular because of the possibility that a window at a completely different position from the desired window may be displayed in the foreground.

Another possible method of displaying the desired window in the foreground is to select the desired window from a list which shows the icons of all the opened windows. This method also has a problem in that there is no relevance between the actual window positions and the arrangement of windows within the list. In this case, the more opened windows are, the less easy it becomes to find the icon or other item associated with the desired window, leading to decreased operational efficiency.

An object of the present information is to provide an information processing apparatus, a window display method, and a computer readable medium to store a display control program which, in multi-window display control, allows a user to select and change the display to his/her desired window quickly with an intuitive operation.

### SUMMARY

A first exemplary aspect of the invention, an information processing apparatus for multi-window display control, includes a change unit which searches among windows displayed on the screen for a window which at least partially overlaps an area identified based on a designated position and changes the display of the found window so that the found window will be sequentially displayed in the foreground on the screen.

A second exemplary aspect of the invention, a widow display method for an information processing apparatus for multi-window display control, comprises a search step of searching among windows displayed on the screen for a window which at least partially overlaps an area identified based on a designated position, and a display change step of changing the display of the found window so that the found window will be sequentially displayed in the foreground on the screen.

A third exemplary aspect of the invention, a computer readable medium storing a display control program which runs on an information processing apparatus for multi-window display control, the display control program comprises a search processing of searching among windows displayed on the screen for a window which at least partially overlaps an area identified based on a designated position, and a display change processing of changing the display of the found window so that the found window will be sequentially displayed in the foreground on the screen.

According to the present information, in multi-window display in which a plurality of windows overlap each other, a user can select and change the display to his/her desired window quickly with an intuitive operation.

### BRIEF DESCRIPTION OF THE DRAWINGS

FIG. 1 is a block diagram which shows the configuration of an information processing apparatus according to a first exemplary embodiment of the present invention;

FIG. 2 is a diagram which shows a window management table used in the first exemplary embodiment;

FIG. 3 is a flow chart which shows an example window display control process according to the first exemplary embodiment;

FIG. 4 is a flow chart which shows an example operation to change the shape and/or size of an area to change according to the first exemplary embodiment;

FIG. 5 is a block diagram which shows the configuration of an information processing apparatus according to a second exemplary embodiment of the invention;

FIG. 6 is a flow chart which shows an example window display control process according to the second embodiment; and

FIG. 7 is a block diagram which shows an example hardware configuration of the information processing apparatus according to the first and the second exemplary embodiments.

### EXEMPLARY EMBODIMENT

### First Exemplary Embodiment

A first exemplary embodiment of the invention will now be described in detail with reference to the drawings.

### Configuration of the First Exemplary Embodiment

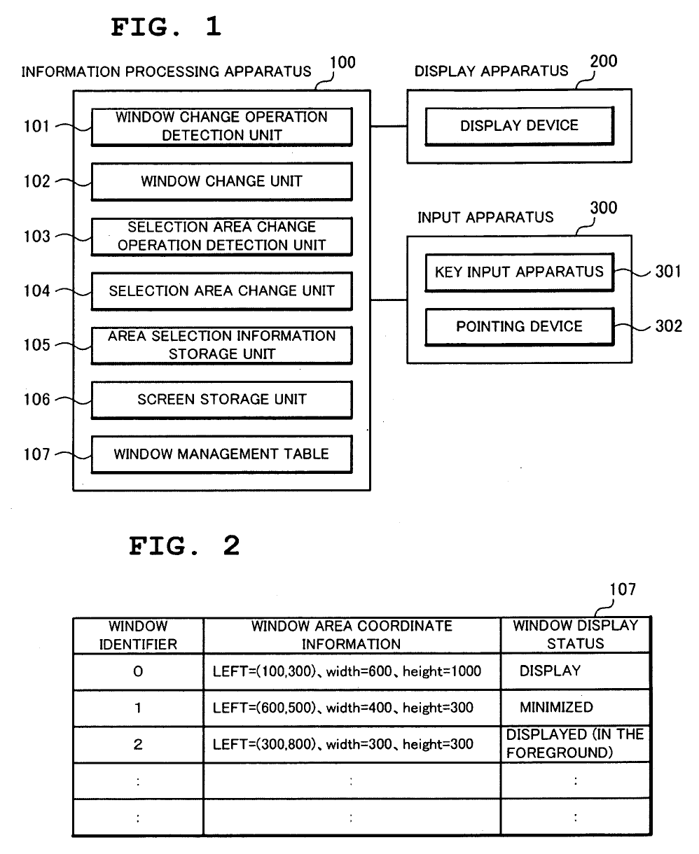

With reference to FIGS. 1 and 2, a configuration of an information processing apparatus according to this exemplary embodiment will be described below.

FIG. 1 is a block diagram which shows the configuration of the information processing apparatus according to this exemplary embodiment, and FIG. 2 is a diagram which shows a window management table stored in a memory.

As shown in FIG. 1, this exemplary embodiment comprises the information processing apparatus 100, a display apparatus 200, and an input apparatus 300. The information processing apparatus 100 is a personal computer, a small mobile terminal or other equipment, and comprises a CPU (Central Processing Unit), which represents an arithmetic unit, and a main storage apparatus (main memory) and an external storage apparatus, which together represent a storage unit. Generally, a magnetic disc apparatus (HDD: Hard Disk Drive) is used as an external storage apparatus. The information processing apparatus 100 also comprises a display mechanism to output display to the display apparatus. Detailed descriptions of these hardware components will be omitted below because they are well known to those skilled in the art and are not directly relevant to the present information.

The display apparatus 200 is realized with a display device, such as an LCD (Liquid Crystal Display) and a CRT (Cathode Ray Tube). This display device is, in general, a bit-map display.

The input apparatus 300 is realized with a key input device 301 and a pointing device 302. In general, the key input device 301 is a keyboard and the pointing device 302 is a mouse or a pen device.

The information processing apparatus 100 comprises a window change operation detection unit 101, a window change unit 102, a selection area change operation detection unit 103, and a selection area change unit 104. The components described above can be realized as software by storing a program which provides the functions of these components and executing the program on the CPU on the information processing apparatus 100. The information processing apparatus 100 further comprises an area selection information storage unit 105 and a screen storage unit 106. These components are realized with a storage apparatus, such as a memory or a magnetic disc apparatus. The storage apparatus of the information processing apparatus 100 stores a window management table 107.

When the user performs a window change operation through the input apparatus 300, the window change operation detection unit 101 detects this operation, and reads the position (coordinates) of the pointer of the pointing device 302 (mouse cursor if the pointing device 302 is a mouse) as of the detection of the change operation. The window change operation detection unit 101 also causes the screen storage unit 106 to store the image of the screen displayed on the display apparatus 200. In a multi-monitor environment, the bit map images of all the monitor screens are stored, rather than only the monitor on which the change operation was performed.

Possible window change operations include an operation of pressing a specific combination of keys of the keyboard 301 simultaneously and a specific action made using the pointing device 302. It should be noted, however, that the concrete content of such operation or action is not limited to specific ones in this exemplary embodiment. Therefore, any operation or action may be configured.

The window change unit 102 calculates a change area for selecting a change-to window, in response to the detection of a window change operation by the window change operation detection unit 101 or based on the position of the pointer read by the window change operation detection unit 101. The window change unit 102 then draws a change area on the screen of the display apparatus 200.

The window change unit 102 also searches the window management table 107 sequentially for a window (change-to window) which at least partially overlaps the change area, and causes the window to be displayed in the foreground on the screen of the display apparatus 200. The window change unit 102 then refreshes the contents of the entries on the window management table 107 according to this display change action.

The selection area change operation detection unit 103 accepts an operation to change the shape and/or size of the change area, performed by the user through the input apparatus 300, and instructs the selection area change unit 104 to refresh the change area. In addition, the selection area change operation detection unit 103 reads the position of the pointer as of accepting the operation and notifies the obtained coordinates to the window change operation detection unit 101.

According to the operation accepted by the selection area change operation detection unit 103, the selection area change unit 104 refreshes the contents stored in the area selection information storage unit 105 to change the shape and/or size of the change area.

The area selection information storage unit 105 stores information concerning the shape and size of the change area for use when selecting a change-to window. These values may be predetermined or may be dynamically changed as the area is selected. The change area is a few-dot range around the coordinates designated with the pointing device (the position of the pointer or the position pointed to by the pointer). The area is generally a rectangle or a circle, but it can be of any shape.

Possible operations to change the shape and/or shape of the change area include an operation of pressing a specific combination of keys of the keyboard 301 simultaneously and a specific action made using the pointing device 302. It should be noted, however, that the concrete content of such operation or action is not limited to specific ones in this exemplary embodiment. Therefore, any operation or action may be configured.

The screen storage unit 106 stores the bit map image of the screen of the display apparatus 200, according to the instruction from the window change operation detection unit 101. This image is used to restore the screen display of the display apparatus 200 upon the completion of the window change process.

The window management table 107 is a table to manage the windows on the screen of the display apparatus 200. In the window management table 107, information which shows the areas of the respective windows and information regarding the display statuses of these windows are registered. As shown in FIG. 2, the window management table 107 contains “window identifiers,” which identify the individual windows, “window area coordinate information” as information regarding the positions, etc. of the individual windows, and “window display statuses,” which indicate the current display statuses of the individual windows.

“Window area coordinate information” above is information which is needed for calculation of window areas. As “window area coordinate information,” any values, not limited to a specific value, can be registered as long as they can identify window areas. For example, they may be a combination of values representing the coordinates of the upper left corner of a window, the width of the window, and the height of the window, as shown in the example of FIG. 2. Alternatively, they may be values representing the coordinates of the upper left corner and those of the lower right corner of a window.

“Window display status” above is information which indicates in what status a window is currently displayed. More specifically, information of whether the window is maximized, minimized or iconized, etc. is recorded as a “window display status.” Also for the window displayed in the foreground on the screen of the display apparatus 200, the information indicating such status is recorded.

It should be noted that information recorded in the “window area coordinate information” item of the window management table 107 is always the information concerning the area of a window in its maximized state, even if the window is minimized or iconized on the screen.

### Operation of the First Exemplary Embodiment

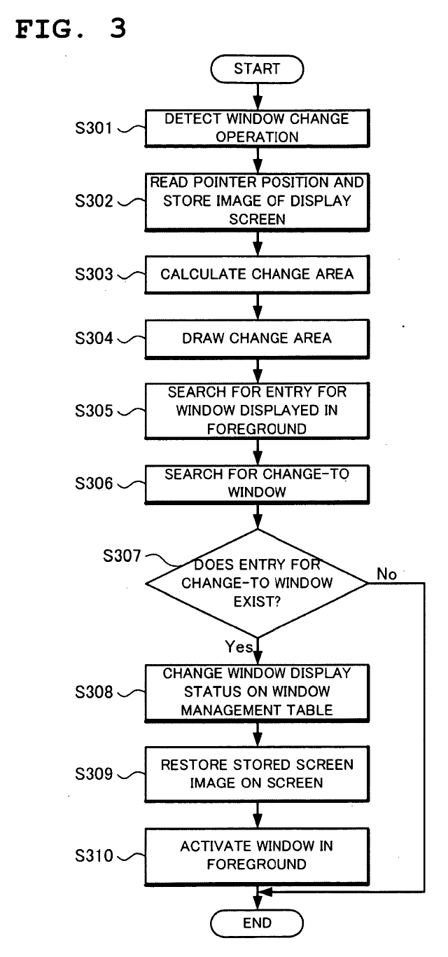

Next, the window display control process performed by the information processing apparatus 100 according to this exemplary embodiment structured as described above will be described, with reference to the flow chart of FIG. 3.

When the user performs a window change operation through the input apparatus 300, the operation is detected by the window change operation detection unit 101 of the information processing apparatus 100 (Step 301). Following this, the position of the pointer is read and the image on the display screen is stored (Step 302).

Then, the window change unit 102 calculates the change area (Step 303). More specifically, the change area is calculated, by using the pointer position read in Step 302 as the reference and based on the information concerning the change area stored in the area selection information storage unit 105. The change area obtained from the calculation is drawn on the screen of the display apparatus 200 (Step 304).

The window change unit 102 then searches for the window management table 107 for the entry for the window currently displayed in the foreground (i.e. the entry whose attribute of the window display status is “displayed (foreground)”) (Step 305). In the example of FIG. 2, this is the window whose “window identifier” is “2.” Following this, the window change unit 102 finds the change-to window (i.e. a window which at least partially overlap the change area) by searching the other entries sequentially, beginning with the entry immediately following the detected entry (Step 306). For this purpose, the target of search may be restricted to the entries whose window display status is “minimized.”

If the entry for the change-to window is found (Yes in Step 307), the window change unit 102 displays the window corresponding to this entry in the foreground and changes its window display status in the window management table 107 to “displayed (in the foreground)” (Step 308). If an entry whose window display status is “minimized” happens to be the entry to change to, the minimized window hidden from the screen will go into a normal display status and be displayed in the foreground on the screen. At the same time, the entry whose window display status on the window management table 107 is originally “displayed (in the foreground)” will be changed to a window display status of “displayed.”

The window change unit 102 then retrieves the screen image stored in the screen storage unit 106 and restores it on the screen of the display apparatus 200 (Step 309). In a multi-monitor environment, the screen images on all the monitors will be restored.

Finally, the window change unit 102 newly searches the window management table 107 for the entry whose “window display status” is “displayed (in the foreground),” and displays the window corresponding to that window identifier in the foreground on the screen of the display apparatus 200 and activates the window (Step 310).

If a window change operation is interrupted or aborted by an explicit operation by the user through the input apparatus 300, the window change unit 102 interrupts the current process and performs the processes of Steps 309 and 310. On completion, the change-to window being searched is displayed in the foreground on the screen of the display apparatus 200 and goes active.

On the other hand, if the change-to window is not found and a search for an entry whose display area overlaps the change area reaches the last entry on the window management table 107, the window change unit 102 goes back to the first entry on the table and continues the search through the window management table 107. If this search reaches the end of the table and returns to the entry whose window display status is “displayed (in the foreground)” (No in Step 307), the window change unit 102 determines that the change-to window does not exist and exits the current window change operation.

In the operation described above, when a window change operation is started with the pointer placed over a specific window, and if a window which at least partially overlaps the change area exists behind the specific window, it is the overlapping window that will be displayed in the foreground. To the contrary, if such other window does not exist, the window originally displayed will remain displayed in the foreground.

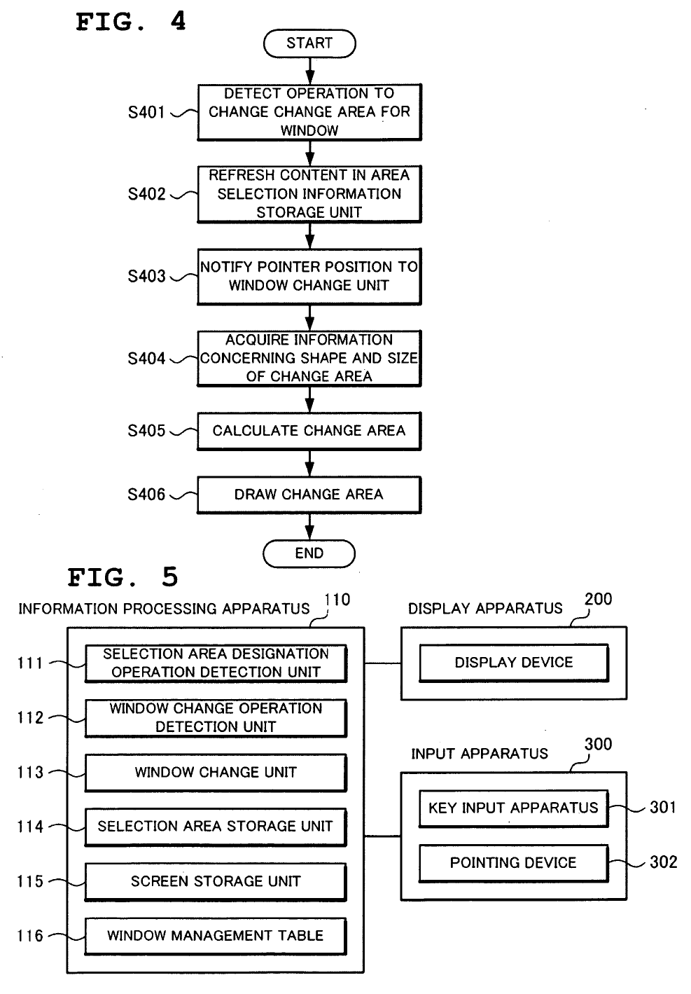

Next, the operation of the information processing apparatus 100 when an operation to change the shape and/or size of the change area is performed will be described, with reference to the flow chart of FIG. 4.

When the user performs an operation to change the change area through the input apparatus 300, the operation is detected by the selection area change operation detection unit 103 of the information processing apparatus 100 (Step 401). The content of the area selection information storage unit 105 is then refreshed (Step 402). In addition, the pointer position is read and notified to the window change unit 102 (Step 403).

On receipt of the notification, the window change unit 102 newly retrieves the information concerning the shape and size of the change area stored in the selection information storage unit 105 (Step 404). Then, the change area is calculated, based on the pointer position received from the selection area change operation detection unit 103 (Step 405). The change area obtained from the calculation is drawn on the screen of the display apparatus 200 (Step 406).

### Effects of the First Exemplary Embodiment

As described above, according to this exemplary embodiment, in multi-window display in which a plurality of windows overlap each other, a user can select and change the display to his/her desired window quickly with an intuitive operation.

This is because, when a window change operation is performed, a window which at least partially overlaps the change area, which is set by using the pointer position as the reference, is searched automatically and, based on the result of the search, the display of the window is changed. The change area above is an area which has a certain expanse and a predetermined shape and size. Therefore, the user can change the window display simply by roughly designating a position with the pointer of the pointing device 302.

### Second Exemplary Embodiment

Next, the second embodiment of the present invention will be described.

### Configuration of the Second Exemplary Embodiment

FIG. 5 is a block diagram which shows the configuration of an information processing apparatus according to this exemplary embodiment.

In this exemplary embodiment, the change area is designated by the user with the pointing device 302, rather than being set by using the pointer position as the reference.

As shown in FIG. 5, this exemplary embodiment comprises the information processing apparatus 110, a display apparatus 200, and an input apparatus 300. The hardware configuration of the information processing apparatus 110 is the same as that of the information processing apparatus 100 according to the first exemplary embodiment. Furthermore, the display apparatus 200 and the input apparatus 300 are the same as the display apparatus 200 and input apparatus 300 of the first exemplary embodiment, and thus their descriptions will be omitted by assigning the same number codes as those of the display apparatus 200 and the input apparatus 300 in FIG. 1.

The information processing apparatus 110 comprises a selection area designation operation detection unit 111, a window change operation detection unit 112, and a window change unit 113. The components described above can be realized as software by storing a program which provides the functions of these components and executing the program on the CPU on the information processing apparatus 110. The information processing apparatus 110 further comprises a selection area storage unit 114 and a screen storage unit 115. These components are realized with a storage apparatus, such as a memory or a magnetic disc apparatus. The storage apparatus of the information processing apparatus 110 stores a window management table 116.

When the user performs an operation to designate a specific area (hereinafter, “selection area”) through the input apparatus 300, the selection area designation operation detection unit 111 detects this operation and stores the information of the designated selection area in the selected area storage unit 114. The selection area is treated as a change area for selecting a change-to window.

Possible operations to designate a selection area include an operation of enclosing a desired area by dragging the pointing device 302. The designation of an area is accomplished by drawing an enclosed shape freehand. If it is difficult to enclose the drawn shape, the drawn shape may be deemed enclosed by, for example, having the start point and the end point of the drawing action connected automatically. It should be noted, however, that the concrete content of such operation or action is not limited to specific ones in this exemplary embodiment.

When the user performs a window change operation through the input apparatus 300, the window change operation detection unit 112 detects this operation, and reads the position (coordinates) of the pointer of the pointing device 302 (mouse cursor if the pointing device 302 is a mouse) as of the detection of the change operation. The window change operation detection unit 101 also causes the screen storage unit 106 to store the image of the screen displayed on the display apparatus 200. Possible window change operations are not limited to specific ones, similarly to the first exemplary embodiment.

The window change unit 113 draws a change area on the screen of the display apparatus 200, in response to the detection of a window change operation by the window change operation detection unit 112 or based on the information stored in the selection area storage unit 114.

The window change unit 113 also searches the window management table 116 sequentially for a window (change-to window) which at least partially overlaps the change area, and causes the window to be displayed in the foreground on the screen of the display apparatus 200. The window change unit 113 then refreshes the contents of the entries on the window management table 116 according to this display change action.

The selection area storage unit 114 stores the information (position, size, etc.) of the area designated with an operation to designate a selection area, according to the instruction from the selection area designation operation detection unit 111.

The screen storage unit 115 stores the bit map image of the screen of the display apparatus 200, according to the instruction from the window change operation detection unit 112. This image is used to restore the screen display of the display apparatus 200 upon the completion of the window change process.

The window management table 116 is a table to manage the windows on the screen of the display apparatus 200. In the window management table 116, information which shows the areas of the respective windows and information regarding the display statuses of these windows are registered.

### Operation of the Second Exemplary Embodiment

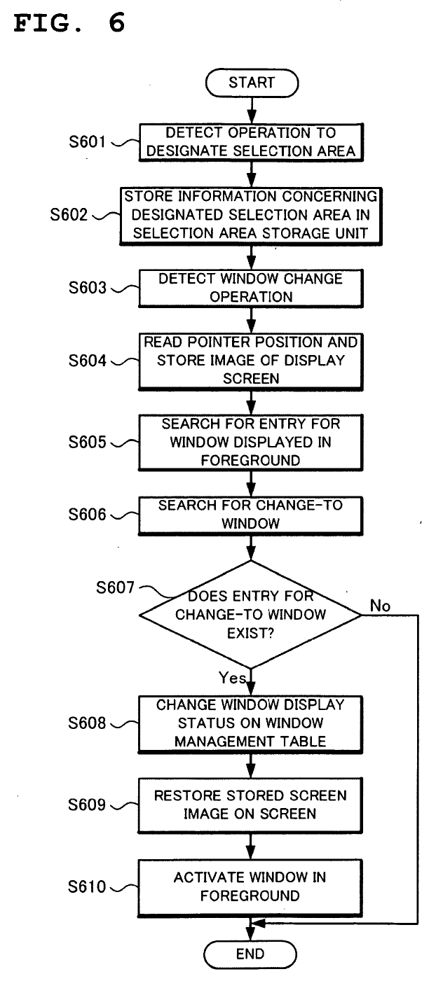

Next, the window display control process performed by the information processing apparatus 110 according to this exemplary embodiment structured as described above will be described, with reference to the flow chart of FIG. 6.

When the user performs an operation to designate a selection area through the input apparatus 300, the operation is detected by the selection area designation operation detection unit 111 of the information processing apparatus 110 (Step 601). The information of the designated selection area is stored in the selected area storage unit 114 (Step 602).

Next, when the user performs a window change operation through the input apparatus 300, the operation is detected by the window change operation detection unit 112 (Step 603), and the image of the display screen is stored (Step 604).

The window change unit 113 then searches the window management table 116 for the entry for the window currently displayed in the foreground (Step 605). After this, a change-to window is searched for sequentially, beginning with the entry immediately following the detected entry (Step 606). For this purpose, the target of search may be restricted to the entries whose window display status is “minimized.”

If the entry for the change-to window is found (Yes in Step 607), the window change unit 113 displays the window corresponding to this entry in the foreground and changes its window display status in the window management table 116 to “displayed (in the foreground)” (Step 608). If an entry whose window display status is “minimized” happens to be the entry to change to, the minimized window hidden from the screen will go into a normal display status and be displayed in the foreground on the screen. At the same time, the entry whose window display status on the window management table 116 is originally “displayed (in the foreground)” will be changed to a window display status of “displayed.”

The window change unit 113 then retrieves the screen image stored in the screen storage unit 115 and restores it on the screen of the display apparatus 200 (Step 609). In a multi-monitor environment, the screen images on all the monitors will be restored.

Finally, the window change unit 113 newly searches the window management table 116 for the entry whose “window display status” is “displayed (in the foreground),” and displays the window corresponding to that window identifier in the foreground on the screen of the display apparatus 200 and activates the window (Step 610).

If a window change operation is interrupted or aborted by an explicit operation by the user through the input apparatus 300, the window change unit 113 interrupts the current process and performs the processes of Steps 609 and 610. On completion, the change-to window being searched is displayed in the foreground on the screen of the display apparatus 200 and goes active.

On the other hand, if the change-to window is not found and a search for an entry whose display area overlaps the change area reaches the last entry on the window management table 116, the window change unit 113 goes back to the first entry on the table and continues the search through the window management table 116. If this search reaches the end of the table and returns to the entry whose window display status is “displayed (in the foreground)” (No in Step 607), the window change unit 102 determines that the change-to window does not exist and exits the current window change operation.

### Effects of the Second Exemplary Embodiment

As described above, according to this exemplary embodiment, a user can select and change the display to his/her desired window quickly, with an even more intuitive operation than the first exemplary embodiment.

This is because a selection area treated as a change area is designated via an area drawn freehand with the pointing device 302. In other words, the user can casually point to a rough position on the screen and designate an area of any desired size at that position, thereby changing the display to a window which overlaps the designated area.

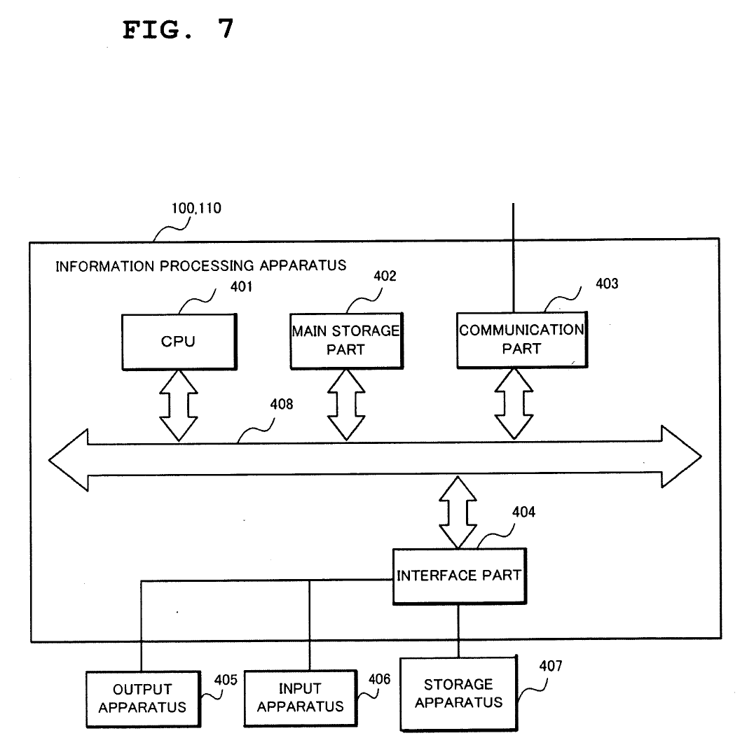

With reference to FIG. 7, the hardware configuration of the information processing apparatus according to the first and the second exemplary embodiments of the invention will be described below.

As shown in FIG. 7, the information processing apparatus 100, 110 can be realized in a hardware configuration similar to a general computer apparatus, and comprises a CPU (Central Processing Unit) 401; a main storage apparatus 402, which is a main memory such as a RAM (Random Access Memory) and which is used as a data work area and/or a temporary save area; a communication part 403, which transmits and receives data to and from other nodes via a network; an input apparatus 405 (which corresponds to an input apparatus 300); an input/output interface part 404, which is connected with output apparatuses 406 (i.e. a display apparatus 200, a printer apparatus and so on) and a storage apparatus 407 to transmit and receive data to and from these apparatuses; and a system bus 408, which connects between the above-described components. The storage apparatus 407 is realized by using, for example, a hard disc apparatus which comprises a nonvolatile memory, such as a ROM (Read Only Memory), a magnetic disc, and a semiconductor memory.

It goes without saying that the operation of the information processing apparatus 100, 101 according to these exemplary embodiments can be realized as hardware by implementing a circuit component, which is a hardware component, such as an LSI (Large Scale Integration), incorporating a display control program for display control in a multi-window environment. In addition, it can also be realized as software by storing a display control program that provides the functions achieved by the window change operation detection unit 101, window change unit 102, selection area change operation detection unit 103, selection area change unit 104, area selection information storage unit 105, screen storage unit 106, etc. in the auxiliary storage part 405, loading the program into the main storage part 402, and executing the program on the CPU 401.

While the present invention has been described by taking several preferred exemplary embodiments as examples, it should be appreciated that the invention is not limited to these exemplary embodiments but can be embodied with a variety of modifications without departing from the technical idea of the present invention.

What is claimed is:

1. An information processing apparatus for multi-window display control, comprising:
a change unit which searches among windows displayed on the screen for a window which at least partially overlaps an area identified based on a designated position and changes the display of said found window so that said found window will be sequentially displayed in the foreground on the screen.

2. The information processing apparatus according to claim 1, comprising a unit which accepts an operation by a user with a pointing device and read a designated position on said screen.

3. The information processing apparatus according to claim 1, wherein said area is an area set to have a predetermined shape and a predetermined size around said designated position on a bit-map display screen.

4. The information processing apparatus according to claim 3, wherein information concerning the shape and size of said area is previously stored and the information concerning the shape and size is changed when a predetermined operation is accepted.

5. The information processing apparatus according to claim 1, wherein said area is an area which is drawn on said screen with a pointer according to an operation of a pointing device.

6. The information processing apparatus according to claim 1, wherein a management table to manage information concerning the positions of windows displayed on the screen is stored and the management table is searched for a window which at least partially overlaps said area.

7. A widow display method for an information processing apparatus for multi-window display control, comprising:
a search step of searching among windows displayed on the screen for a window which at least partially overlaps an area identified based on a designated position; and
a display change step of changing the display of said found window so that said found window will be sequentially displayed in the foreground on the screen.

8. The window display method according to claim 7, further comprising a step of accepting an operation by a user with a pointing device and reading a designated position on said screen.

9. The window display method according to claim 7, wherein said search step searches for a window which at least partially overlaps said area set to have a predetermined shape and a predetermined size around said designated position on a bit-map display screen.

10. The window display method according to claim 9, wherein said search step further includes a step of identifying said area based on the previously stored shape and size of said area; and
accepting a predetermined operation and changing the stored information concerning the shape and size of said area.

11. The window display method according to claim 7, wherein said search step searches for a window which at least partially overlaps said area drawn on said screen with the pointer by an operation of the pointing device.

12. The window display method according to claim 7, wherein said search step searches a management table to manage information concerning the positions of windows displayed on the screen for a window which at least partially overlaps said area.

13. A computer readable medium storing a display control program which runs on an information processing apparatus for multi-window display control, said display control program comprising the processing of:
a search processing of searching among windows displayed on the screen for a window which at least partially overlaps an area identified based on a designated position; and
a display change processing of changing the display of said found window so that said found window will be sequentially displayed in the foreground on said screen.

14. The computer readable medium according to claim 13, further comprising a processing of accepting an operation by a user with a pointing device and reading a designated position on said screen.

15. The computer readable medium according to claim 13, wherein said search processing searches for a window which at least partially overlaps said area set to have a predetermined shape and a predetermined size around said designated position on a bit-map display screen.

16. The computer readable medium according to claim 15, wherein said search processing further includes a process of identifying said area based on the previously stored shape and size of said area; and
accepting a predetermined operation and changing the stored information concerning the shape and size of said area.

17. The computer readable medium according to claim 13, wherein said search processing searches for a window which at least partially overlaps said area drawn on said screen with the pointer by an operation of the pointing device.

18. The computer readable medium according to claim 13, wherein said search processing searches a management table to manage information concerning the positions of windows displayed on the screen for a window which at least partially overlaps said area.
